(19) United States
(12) Patent Application Publication
(10) Pub. No.: US 2004/0256375 A1
(43) Pub. Date: Dec. 23, 2004

(54) Electrical water heating device with large contact surface

(76) Inventors: Irina Loktev, Jerusalem (IL); Papirov Igor, Jerusalem (IL)

Correspondence Address: KATTEN MUCHIN ZAVIS ROSENMAN, 575 MADISON AVENUE, NEW YORK, NY, 10022-2585, US

(21) Appl. No.: 10/489,692

(22) PCT Filed:
(86) PCT No.: PCT/IL02/00754

(30) Foreign Application Priority Data
Sep. 13, 2001 (IL) 145426

(51) Int. Cl. H05B 3/78; F27D 11/00

(52) U.S. Cl. 219/438; 392/485

(57) ABSTRACT

The tubular water device comprises an inner conduit, an outer conduit, substantially surrounding said inner conduit, an electro-resistive heating element, disposed adjacently to an outer surface of said inner conduit for transferring thermal energy to fluid contained in inner chamber and in outer chamber; a continuous metal sheath, substantially covering and sealing said electro-resistive heating element, forming monolithic tight heating tube. As heating material a crystalline metal foil is used. It is shown different applications.

### BACKGROUND OF THE INVENTION

The proposed invention belongs to the area of water electro-heating device in a tubular form.

Electro-heating devices were known in a form of a tube, which comprise wire with high resistance and electro-insulating material in a form of quartz sand inside of tube. There are varieties of electric boilers, which currently use the above heaters (see, for example, U.S. Pat. Nos. 4,762,980, 4,567,350, 4,604,515). Thee heaters are used everywhere for water heating into boilers and for heating of water flow. They are effective and technology of their manufacturing is not expensive.

However, they have some disadvantages: due to their high power and small surface, their surface temperature is high, and the water around the heating element is on the boil. However water layers, which are further from electric element, are heated slowly. For domestic consumption the water temperature must not exceed 40-50° C.

Besides, high temperature of such heating elements furthers to precipitation of hard salts (“stone”) on heating element surface.

It is known heating pipe, including “a tubular electrically isolative inner element, configured to allow flow a liquid there through” (see U.S. Pat. Nos. 5,641,421; 5,862,303; 6,069,997; 6,128,439). In these patents an electric heating element is made in the form of a flat ribbon of overheated amorphous metallic alloy. The ribbon is wound in a helical pattern around an inner plastics pipe. This pipe insulates the heating ribbon tom liquid in the inner pipe. The heating ribbon is covered by outer plastics element of electrical and heat insulation. Using of heating ribbon provides large dimensions and low temperature of the surface, contacting in water. But the heating pipe in accordance with pointed patents has some disadvantages. Amorphous alloy keeps unpacked state up to 100° C. Temperature of the heating ribbon of amorphous alloy inside the plastics heating pipe will be higher because low thermo-conductivity of plastics. Besides, in descend design water flows only inside the plastics pipe. Therefore, above mentioned device does not provide reliability.

The aim of the proposed invention is to increase the heating uniformity and to accelerate the heating process. This is achieved by the way of increasing of heating material surface and water mixing during of heating process. Simultaneously the aim of the proposed invention is to avoid precipitation of hard salts and to increase reliability and life span of heaters. In this invention the design, which provides both electro-heating and water purification, are described.

### OBJECTS OF THE INVENTION

It is an object of the present invention to provide an electrical heating device for fluids.

It is a more particular object of the present invention to provide an in-line electrical heating device, which may be readily joined to other components in a fluid distribution system.

It is a further object of the present invention to provide an electrical heating device of low thermal mass.

Still a further object of the present invention is to create a heating element with large area to avoid a precipitation of hard salts (“stone”).

Still a further object of the present invention is to heat water at a high flow rate without bumping or local overheating or boiling.

It is still a further object of the present invention is to create an in-line heater, which presents minimum impedance to fluid flow at a fixed heating rate.

These and other objects of the present invention will be apparent from drawings and descriptions therein.

### SUMMARY OF THE INVENTION

An electrical beating device in accordance with the present invention includes an extended heating element in the form of a linear electrical resistance element wound about a metal conduit. The conduit has an inlet and outlet with provision for thermal contact with a fluid flowing along both an inside and an outside surface of the profile. The conduit together with the heating element is enclosed within outer conduit of enlarged diameter, inside of which the inner conduit forms an insert. Outer conduit may be made from both metal and plastics.

To facilitate using of a heated conduit, having an inner surface and an outer surface in beat conductive contact with a flowing fluid, it is necessary that heated conduit be sealed with respect to a working fluid within which it is immersed.

A space inside of the inner conduit firms an inner chamber. A space between inner and outer conduits forms an outer chamber. A flexible heating element is disposed adjacently to an outer surface of the inner conduit and wrings out it, transferring thermal energy to fluid contained in the inner chamber and the outer chamber. A continuous metal sheath covers and seals the heating element, forming monolithic tight heating tube.

A device for heating a flowing fluid has a first end for entering water flow and a second end for going away flow. An inner chamber has an inlet end and an outlet end. The outer chamber has an inflow end and an outflow end. The inner and outer conduits and the device are configured such, that a flow directed from the first end of the device to the second end of the device will partially transverse the inner chamber substantially from the inlet end to the outlet end, and partially transverse the outer chamber substantially from the inflow end to the outflow end. The inlet end and inflow end are disposed adjacent to the fir end, and the outlet end and the outlet end are disposed adjacent to the second end.

The present invention proposes other design, wherein the first end and the second end are disposed in one side of the water heating device. In this case the inlet end of the inner chamber is disposed adjacent to the first end, and the outlet end of the inner chamber is disposed adjacent to the inflow end of the outer chamber and the outflow end is disposed adjacent to the second end. Dimensions of parts of described structure are chosen such that the flow resistance is not increased

The present invention proposes also to cover and to seal the heating element by a continuous metal sheath. A continuous metal sheath hugs the heating element. Together they form a monolithic tight heating tube. This sheath can be made by electroplating, which provides both hugging and sealing of the heating assembly.

The electro-resistive heating element comprises a substantially flexible flat resistor in the form of a winding.

In accordance with the present invention the resistive flexible heating material made in a form of a thin tape, consists of metal alloy foil with high resistance or of carbon materials.

In the first case the heating ribbon is made of a crystalline metal foil, which provides operating temperature higher than 300° C. In another case the heating ribbon consists of a carbon material particularly, of carbon fiber or carbon fabric.

Electro-resistive heating element includes at least one inner layer of electrical thermo-conductive insulation, which hugs the inner conduit. For example, silicon rubber sheet may be used as the insulating material The resistive material in a form of a thin tape is wound on the said insulating layer and is wrung out by the second (outer) insulating layer. The ends of heating tape are joined with electro conductive wire for connection to power supply. The second (outer) layer of electrical thermo conductive insulation is coated by the additional metal sheath, which is made by electroplating method. The sheath wrings out the said outer insulation layer and ends of the said tube, forming monolithic tight tubular electro-heating device.

In another design, the electro-resistive heating element is made as a heating strip, consisting of heating material in a form of a flexible thin tape, pressed out by at least one electrical insulating thermo-shrinkable sleeve. The strip is wound on said inner conduit and is connected with cable for power supply. This structure is simpler for manufacturing, but thermo-shrinkable sleeves do not have high thermo-conductivity. Therefore, such structure may be used in devices with relatively low required specific power of the heating element. For example, such element may be successfully used for heating of boilers, since in this case large surface of hearer helps to uniform and quick heating. A continuous metal electroplated sheath hugs the heating strip and the inner conduit. Together they form a monolithic tight heating tube.

In accordance with the present invention, another design of the electro-resistive heating element is made as a heating strip, consisting of heating material in a form of a flexible thin tape or of a bun of carbon fibers, freely disposed in at least one electrical insulating thermo-conductive sleeve. Free disposition of the heating tape and insulating sleeve allows to wind the heating strip on the inner conduit tightly and does not provoke temperature stress in the materials. This sleeve is made of thermo-conductive materials for example, silicon rubber. The strip is wound on the inner conduit and is connected with cable for power supply. A continuous metal electroplated sheath hugs the heating strip and the inner conduit.

The electro-resistive heating element may be made also as a heating strip, consisting of heating material in a form of a flexible thin tape, coated by at least one layer of electrical insulating thermo-conductive material. A two-component liquid silicon rubber is used as pointed material. This strip is wound on the inner conduit and is connected with cable for power supply. In this case a continuous metal electroplated sheath also hugs the heating strip and the inner conduit.

In all structures the winding may include a double-helical winding.

In accordance with the present invention the inner and outer conduits consist of a tube, made of any profiles. The simplest profile is a pipe. Standard metal pipes may be used as inner and outer tubes. Besides, profiles may have, for example, a rectangular form. For increasing of surface area the inner profile may be provided by ribs. The profile also may contain inner cavities. Part of these cavities may be used for water flow, and another part is intended for connecting wires. Such division of dry and moist zone provides simultaneously reliable scaling of the heating element and increased of surface area.

For acceleration of water heating process tubular electro-heating device for water heating may contain one or two additional metal inserts in a cored cylindrical shape (for example, as a spiral or ribbed form).

The first of them is disposed inside the inner tube into water flow and is intended for improving heat transfer between a working fluid and a wall of the inner cavity. The second of them is disposed in the space between inner and outer tubes and is intended for improving scat transfer between a working fluid and a wall of the outer cavity. These inserts provide division of water flow and speeded up water heating.

Tubular electro-heating device may be used simultaneously as a water improving device. In this case the insert is covered by zinc and/or by precious or semi-precious metals, simultaneously providing speeded up water heating and water improving by flow passing through the tube with above insert.

Application of water improving device in space of the heater provides additional effects both for heating and for water improving processes. On one side, metal surface of water improving device increases a surface of heater and accelerates the heating process On second side, a heating element with large area prevents local overheating or boiling and a precipitation of hard salts (“stone”).

The described combination of two parts with two functions (heating and water improving) in one device is not sum of two functions only, but this combination gives the new effect, conditioned by mutual influence of metal water improving device to heating process and of water heating to process of water improving.

The tubular electro-heating device for water heating with insert, disposed between inner and outer tubes, may be made by electroplating together with the electroplated sheath on the inner tube as monolithic tight, simultaneously providing improved thermo-change and improved water quality.

The tubular electro-heating device additionally contains a temperature sensor (for example, thermo-switch), built in the metal electroplated sheath. Thermo-switch is used for device protection.

On basis of described tubular heating devices the system of water heating may be realized. This system comprises the described device for heating a flowing fluid, which is built in closed circuit, containing water radiators, water tubes, a water vessel and pump, providing water circulation in the system.

For increasing of system power, the devices for heating a flowing fluid are connected such, that water flows pass them serially or in parallel.

The present invention proposes the water heating device, which is intended for heating of water tank. Heaters for water tank do not require high power density. For improving of thermo-change between water and heating device and water mixing during of heating process a heater with large area in a shape of a pipe with larger diameter is more advantageous. Therefore, this heater has relatively low specific power. Surface temperature of this heater does not exceed 80° C. Such heater simultaneously solves two problems: quick heating and preventing of hard salt precipitation.

The heating device for water tank consists of a flexible heating strip, made from above mentioned heating material in a form of a flexible thin tape, pressed out by at least one electrical insulating thermo-shrinkable sleeve, forming a heating strip. This strip is embedded in additional metal braided sleeve and wound in a shape of a tube.

Additionally the described heating device may be coated by additional metal electroplated sheath.

The present invention proposes also other design of water tank heater. This heater consists of metal tube, the fist insulation layer, made of shrinking hose, which hugs this tube, said tape of one of above mentioned heating materials and the second insulation layer, made of shrinking hose. All sandwich is covered by electroplated sheath. In this case application of thermo-shrinking hose is possible,

In accordance with the present invention an electrical boiler is created with using of described electro-heating device. The device is joined with boiler flange and is positioned so that its inlet end is placed in lower boiler section and its outlet end is positioned in upper boiler section.

The present invention allows to obtain the heating uniformity and acceleration of the heating process. This is achieved by the way of increasing of heating element surface and water mixing during of heating process. The proposed invention allows also to avoid precipitation of hard salts and to increase reliability and life span of heaters.

All these goals can be attained using the proposed new electric heating devices.

### BRIEF DESCRIPTION OF THE DRAWINGS

The proposed invention is illustrated by means of the enclosed drawings, where:

FIG. 1 is an elevational view of a helically wound tubular electric flow-through-type electro-resistive water heater in accordance with the present invention.

FIG. 2 is an elevational view of the modification of the helically wound tubular water heater in accordance with the present invention.

FIG. 3 is an elevational view of monolithic tight heating tube (the heating inner tubular assembly) in accordance with the present invention.

FIG. 4 is an elevational view of the ating inner tubular assembly with strip as a heating element in accordance with the present invention.

FIG. 5 is an elevational view of heating strip with the metal heating tape in accordance with the present invention.

FIG. 6 is an elevational view of heating strip with the metal heating tape, made as a double-helical winding in accordance with the present invention.

FIG. 7 is an elevational view of heating strip with the carbon fibers in accordance with the present invention.

FIG. 8 is an elevational view of heating strip with heating materials, coated by thermo-conductive polymerized mass in accordance with the present invention.

FIG. 9 is an elevational view of tubular electric heating device from metal profile (cross section) in accordance with the present invention.

FIG. 10 is an elevational view of the heating inner tubular assembly with additional water improver in accordance with the present invention.

FIG. 11 is an elevational view of the assembly of heating devices, connected in series in accordance with the present invention.

FIG. 12a is an elevational view of the heating device in a shape of one-line strip with heating metal ribbon for boiler in accordance with the present invention.

FIG. 12b is an elevational view of the heating device in a shape of double-helical winding for boiler in accordance with the present invention.

FIG. 12c is an elevational view of the heating device in a shape of one-line strip with heating carbon as for boiler in accordance with the present invention.

FIG. 13 is an elevational view of the electrical boiler with the built-in heating device in accordance with the present invention.

### DESCRIPTION OF PREFERRED EMBODIMENTS

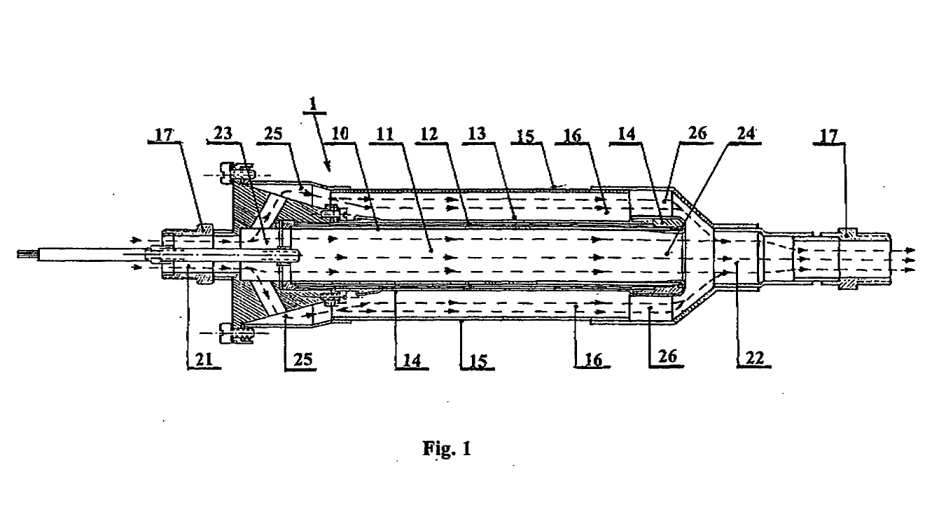

A helically wound tubular instantaneous-type electro-resistive water heater 1 is depicted in FIG. 1. This is a compact in-line tubular electro-heating device for incorporation in a plumbing system.

The inner conduit 10 defines the inner chamber 11. Electro-resistive heating element 12 is disposed adjacently to an outer surface of the inner conduit 10. The heating element 12 is covered and scaled by metal sheath 13. The inner tubular assembly covered by above sheath, forms monolithic tight heating tube 14.

The outer tube 15 surrounds the inner assembly 14. Space between inner tubular assembly 14 and outer conduit 15 defines the outer chamber 16. The device 1 is provided with bushings 17 for connection with other piping elements, forming a first end 21 and a second end 22. The inner chamber 11 has an inlet end 23 and an outlet end 24. The outer chamber 16 has an inflow end 25 and an outflow end 26.

FIG. 1 shows the water heater construction 1, in which water flows in inner chamber and in outer chamber have identical directions, i.e. the chambers are flowed in parallel. In this case the inner and outer conduits are configured such, that a flow is directed from the first end 21 of the device to the second end 22 of the device. The flow partially transverse the inner chamber 11 from the inlet end 23 to the outlet end 24, and partially transverse the outer chamber 16 from the inflow end 25 to the outflow end 26. The inlet end 23 and the inflow end 25 are disposed adjacent to the first end 21. The outlet end 24 and the outflow end 26 are disposed adjacent to the second end 22.

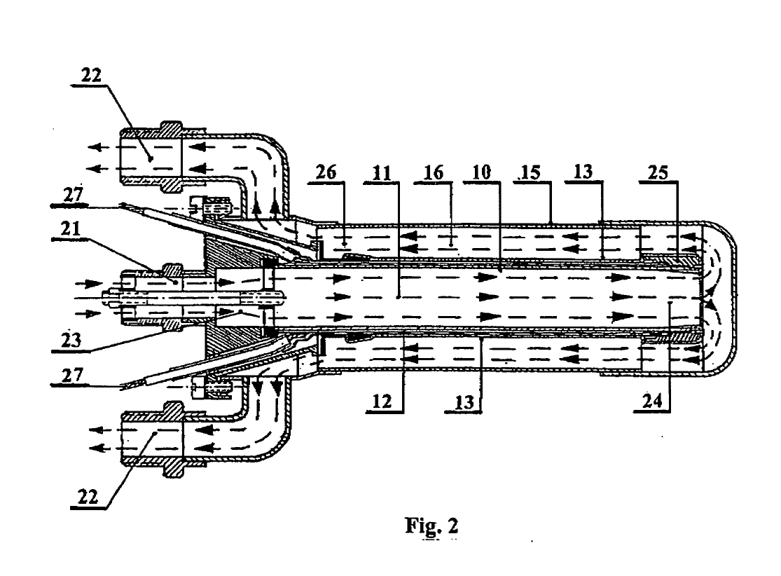

In some cases it is convenient to have the first end and the second end on one side of the heating device. A modification of the water heater with one sided disposition of the ends is depicted in FIG. 2. In this construction the inner chamber 11 and outer chamber 16 arm flowed serially. The inlet end 23 is disposed adjacent to the first end 21. The outlet end 24 is disposed adjacent to the inflow end 25 and the outflow end 26 is disposed adjacent to the second end 22.

In FIG. 1 and FIG. 2 the continuous metal sheath 13 is shown. The sheath is made by electroplating technology. Electroplating allows to obtain the covering, which hugs said heating element and said ends of said inner conduit. FIG. 2 shows electrical wires 27, which connect the heating element 12 with power supply.

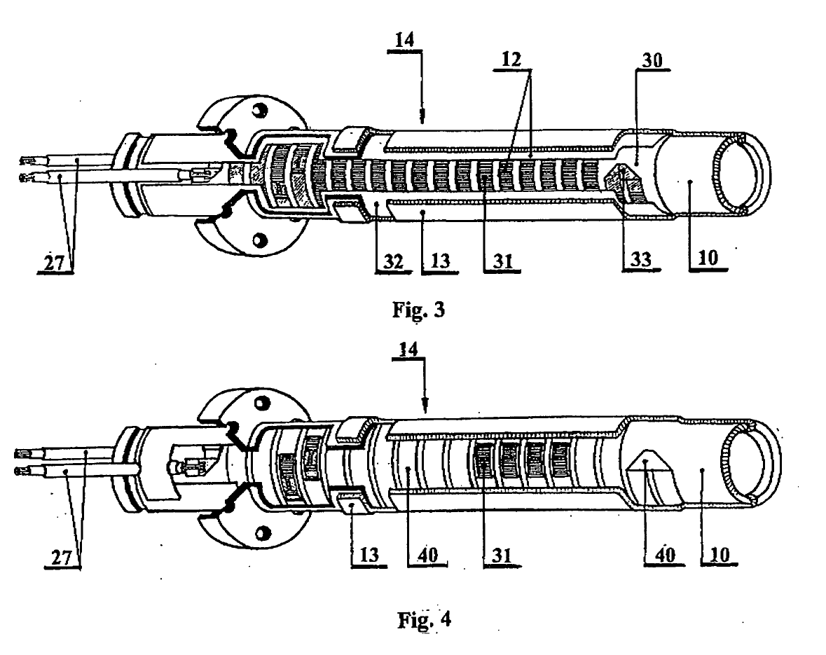

FIG. 3 illustrates the inner tubular assembly. The inner tubular assembly 14 comprises an inner conduit 10, the heating element 12 and electroplated sheath 13. The heating element 12 consists of some insulating layers and electrical heating material. The first (inner) layer of electrical insulation 30 is positioned on the tube 10. Electrical heating material in a form of a tape 31 is wound on the inner insulating layer 30. The ends of the tape are connected with electrical conductors 27, providing power supply of heating tape 31. The outer insulating layers 32 are placed on the heating tape 31. The metal sheath 13 wrings out the outer insulating layer 32, forming monolithic tight tubular electroheating device 14. Each of inner and outer insulation layers may contain two thin insulation layers. The heating tape is made as a double-helical winding. Place 33 of winding bending is covered by high conductive metal.

Heating tape 31 is a thin tape, made from metal alloy foil with high resistance or from carbon fibers or carbon fabric. The metal tape has thickness 20-50 microns.

FIG. 4 depicts another design of the inner tubular assembly. Here a heating strip 40 is wound on the tube 10 and is covered by electroplated metal sheath 13. Different types of strips are used depending on application of the heater.

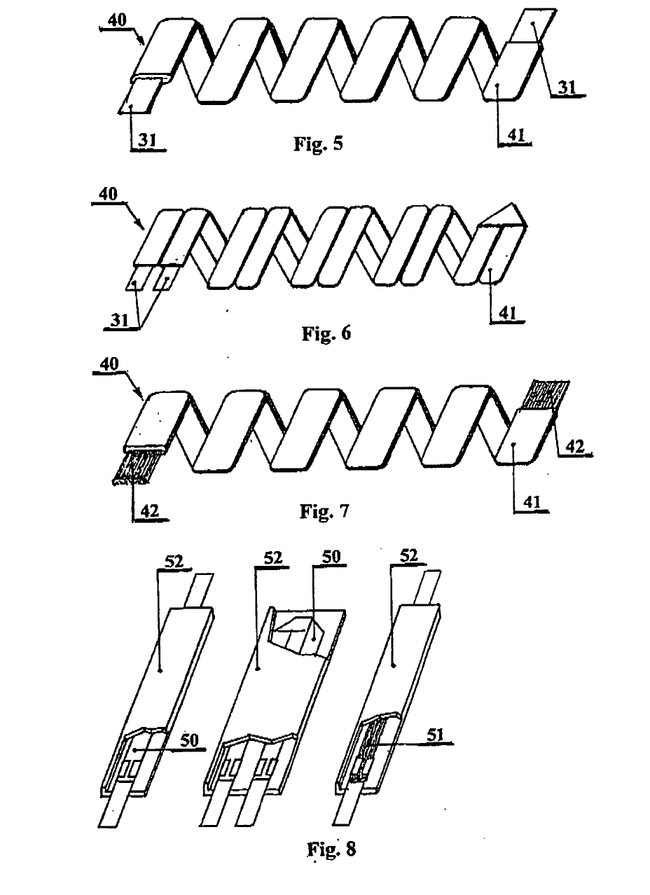

For flow-through-type electro-resistive water heater with required high volume of electrical power, the strip 40 (FIG. 5) contains the heating tape 31, an electrical insulation 41 with high thermo-conductivity, for example, silicon-rubber sleeve. The heating tape 31 is disposed freely in the sleeve 41, that provides dense hugging of the tube 10 by the strip 40, FIG. 6 shows the same strip, made as a double-helical winding. FIG. 7 illustrates the strip, which contains carbon fibers 42 as heating material.

For boiler heater, when it is advantageous to have a heater with large contact area, i.e. with low specific power, strips with thermo-shrink hose may be used.

FIG. 8 illustrates a heating strip, consisting of heating material (thin metal tape 50 or carbon material 51 in a form of a flexible thin tape, coated by at least one layer of electrical insulating thermo-conductive material 52. A liquid silicon rubber is used as pointed material.

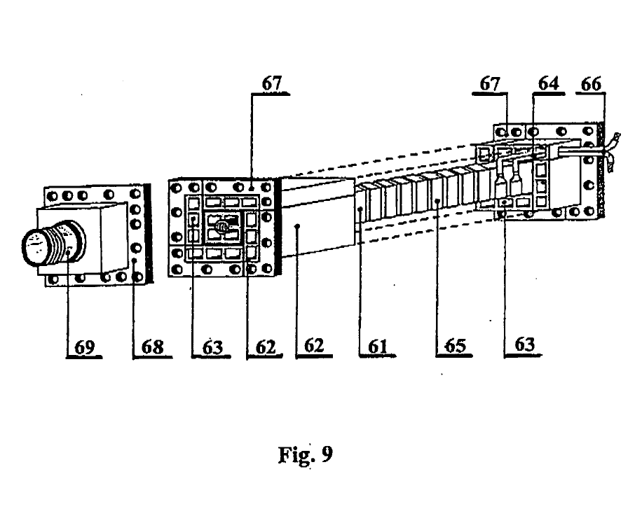

FIG. 9 shows the tubular electro-heating device from metal profile, for example, from aluminum profile. Profiles are used both as the inner tube 61 and as an outer shell. The outer shell is made from profiled sections 62 with internal channels 63, 64. The inner tube is wrung out by a heating strip 65. The sections of outer shell 62 are arranged on the heating strip 65. The channels 64 are used for connection of power supply cable 66. A casing 67 joins the ends of inner tube 61 and outer shell 62. A cap 68 with pipe connector 69 provides water flow in the channels of the inner tube 61 and in the channels 63.

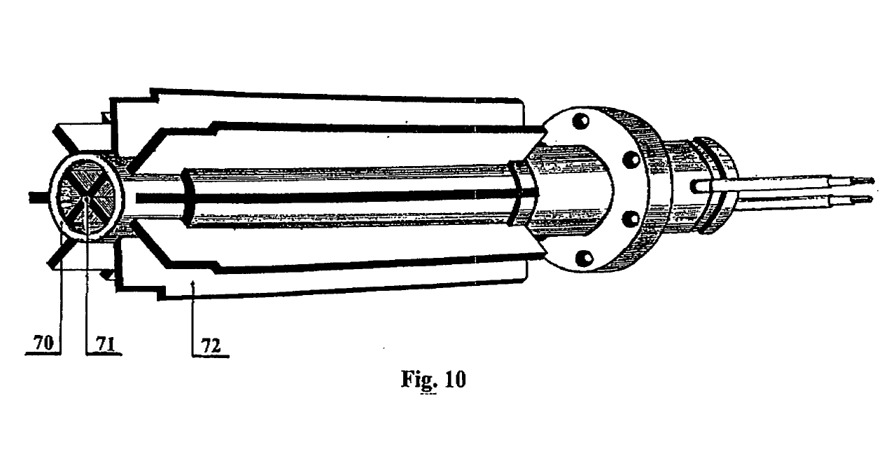

FIG. 10 depicts a tubular electro-heating device with additional metal inserts, which extends a heating surface, simultaneously providing speeded up water heating and preventing of precipitation of hard salts in the heater. The first insert 71 is placed in water flow inside of the inner tube 70. The second insert 72 in a ribbed form is placed between inner tube 70 and outer tube.

The heater additionally contains a temperature sensor (for example, thermo-switch), built in the said metal electroplated sheath.

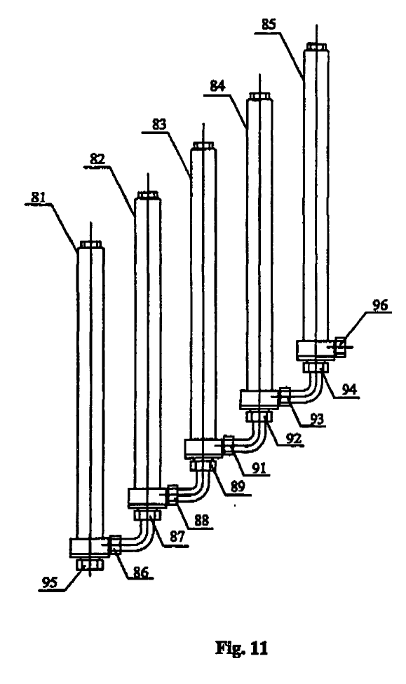

The described heaters are intended for embedding in a heating system, wherein the device is built in closed circuit, containing water radiators, water tubes, a water vessel and pump, providing water circulation in the system. For increase the electrical power, the system may contain several devices for heating a flowing fluid, joined so that water flow pass each device serially or in parallel. FIG. 11 shows several heating devices 81, 82, 83, 84, 85 joined in series. In this assembly the second end 86 of the heater 81 is connected with the first end 87 of the heater 82, the second end 88 of the heater 82 is connected with the first end 89 of the heater 83, etc. The assembly is connected with water system by the first common end 95 and the second common end 96.

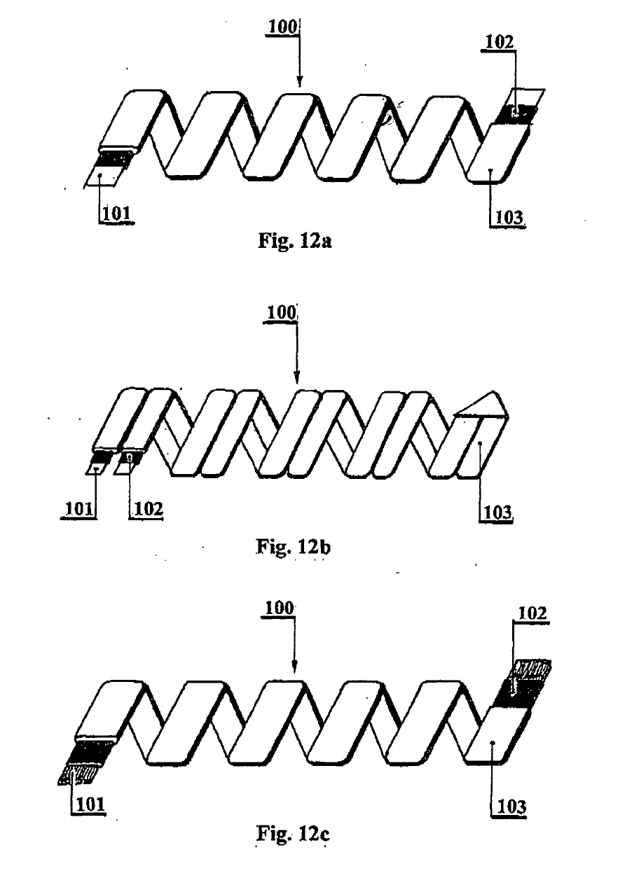

Other application of the water heating devices with large contact surface is heating of water tanks. Different variants of strips for boiler are shown on FIG. 12. The heater 100 contains a flexible heating ribbon 101, made of the metal foil (FIG. 12a, b) or carbon fibers (FIG. 12c) and is made in a form of a flexible thin tape, pressed out by at least one electrical insulating thermo shrinkable sleeve 102, wound in a shape of a tube and embedded in a metal braided sleeve 103. This heater may be coated by additional metal electroplated sheath.

The heater may be made as one-line strip (FIG. 12a, FIG. 12c) or as a double-helical winding (FIG. 12c).

In another design of heater for water tank the heater consists of metal tube, embedded in shrinking hose, which hugs this tube. The tape of one of above mentioned heating materials is disposed on the shrinking hose. This sandwich is embedded in the second shrinking hose and covered by electroplated sheath.

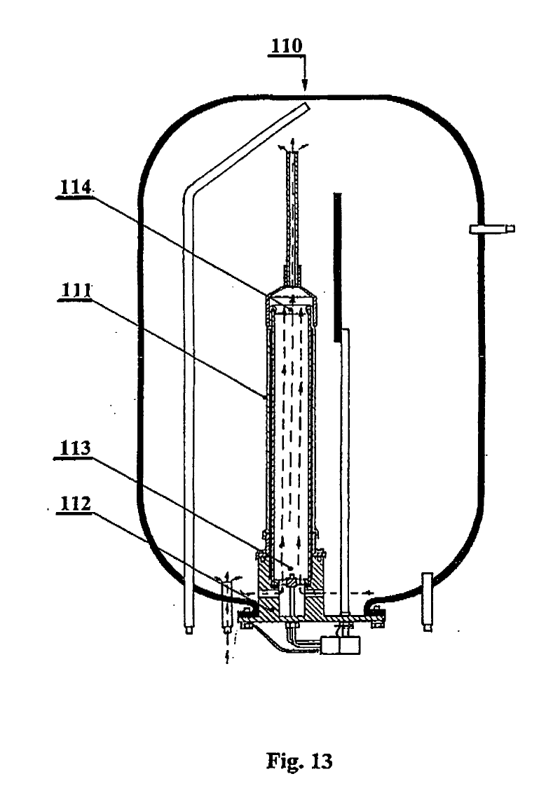

FIG. 13 illustrates an electrical boiler 10, using the described electro-heating device. The device 111 is joined with boiler flange 112 and is positioned so that its inlet end 113 is placed in lower boiler section and its outlet end 114 is positioned in upper boiler section.

The invention has been described in an illustrative manner, and it is to be understood that the terminology, which has been used, is intended to be in the nature of words of description rather than of limitation. Clearly, many modifications and variations of the present invention are possible in light of the above teachings. For example, described design with two-sided water flow (inside and outside of heating element), which increases contact surface of heater walls and water, using of electroplated metal sheath for described aims provide high reliability and life span of the heating device. Accordingly, it is to be understood that the invention can practiced otherwise than specifically described.

1. A device for heating a flowing fluid, comprising:
an inner metal conduit defining an inner chamber;
an outer conduit substantially surrounding said inner conduit defining an outer chamber;
an electro-resistive heating element, disposed adjacently to an outer surface of said inner conduit for transferring thermal energy to fluid contained in said inner chamber and said outer chamber;
a continuous metal sheath substantially covering and sealing said electro-resistive heating element, forming monolithic tight heating tube.

2. A device of claim 1, comprising:
a first end and a second end, wherein said inner chamber has an inlet end and an outlet end, said outer chamber having an inflow end and an outflow end, said inner and outer conduits and device being configured such, that a flow directed from said first end of the device to said second end of the device will partially transverse said inner chamber substantially from said inlet end to said outlet end, and partially transverse said outer chamber substantially from said inflow end to said outflow end, said inlet end and inflow end being disposed adjacent to said first end, and said outlet end and said outflow end being disposed adjacent to said second end.

3. A device of claim 1,
wherein said inlet end being disposed adjacent to said first end, and said outlet end being disposed adjacent to said inflow end and said outflow end being disposed adjacent to said second end.

4. The device of claim 1,
wherein said continuous metal sheath is made as electroplated sheath, which hugs said heating element and said ends of said inner conduit.

5. The device of claim 1,
wherein said electro-resistive heating element comprises a substantially flat resistor in the form of a winding.

6. The device of claim 5,
wherein the flat resistor is heating tape, made of a crystalline metal high electrical resistance foil.

7. The device of claim 5,
wherein the flat resistor is made of carbon materials, such as carbon fabric or carbon fibers.

8. The device of claim 5,
wherein said electro-resistive heating element comprises:
at least one inner layer of electrical thermo-conductive insulation, which hugs the said conduit;
thin flexible resistor in a form of a thin tape, wound on the inner insulation layer;
at least one outer layer of electrical thermo-conductive insulation, which hugs said flexible heating material and said inner layer of electrical insulation;
electro-conductive wire for connection of said heating tape with power supply.

9. The device of claim 5,
wherein said electro-resistive heating element is made as a heating strip, consisting of a heating material in a form of a flexible thin tape, pressed out by at least one electrical insulating thermo-shrinkable sleeve, said strip is wound on said inner conduit and is connected with cable for power supply.

10. The device of claim 5,
wherein said electro-resistive heating element is made as a heating strip, consisting of heating material in a form of a flexible thin tape, freely disposed in at least one electrical insulating thermo-conductive sleeve, said strip is wound on said inner conduit and is connected with cable for power supply.

11. The device of claim 5,
wherein said electro-resistive heating element is made as a heating strip, consisting of heating material in a form of a flexible thin tape, coated by at least one layer of electrical insulating thermo-conductive material, such, for example, as a liquid silicon rubber mass, said strip is winded on said conduit and is connected with cable for power supply.

12. The device of claim 5,
wherein said winding includes a double-helical winding and place of winding bending is covered by high conductive metal.

13. The device of claim 2,
wherein said inner conduit comprises a first profile defining said inner chamber, and said outer conduit comprises a second profile defining said outer chamber, said profiles being chosen from the group: a round form, a rectangular form, a rectangular form with inner cavities, smooth or ribbed.

14. The device of claim 2,
wherein said inner chamber contains a first metal insert for improving heat transfer between a working fluid and a wall of said inner cavity, said first insert being chosen from the group: a spiral form, a ribbed form.

15. The device of claim 2,
wherein said outer chamber contains a second metal insert for improving heat transfer between a working fluid and a wall of said outer cavity, said second insert being chosen from the group: a spiral form, a ribbed form.

16. The device of claim 14,
wherein said inserts are covered by zinc and/or precious or semi-precious metals, simultaneously providing speeded up water heating and water improving by flow passing through the conduits with above insert.

17. The device of claim 1,
which additionally comprises a temperature sensor, built in said metal sheath.

18. The system of water heating,
which comprises said device for heating a flowing fluid,
wherein said device is built in closed circuit, containing water radiators, water tubes, a water vessel and pump, providing water circulation in the system.

19. The system of water heating of claim 18,
which contains several devices for heating a flowing fluid, joined such that water flow pass them in series or in parallel.

20. A device for water tank heating,
which consists of a flexible heating strip, made of said heating material in a form of a flexible thin tape, pressed out by at least one electrical insulating thermo-shrinkable sleeve, which is embedded in additional metal braided sleeve and wound in a shape of a tube, and it is joined with boiler flange and is positioned so that its inlet end is placed in lower boiler section and its outlet end is positioned in upper boiler section.

21. A device of claim 20,
wherein said strip additionally covered by electroplated sheath.

22. A device of claim 8,
wherein layers of electrical thermo-conductive insulation is made of shrinking hoses.
